(19) United States
(12) Patent Application Publication
(10) Pub. No.: US 2024/0118923 A1
(43) Pub. Date: Apr. 11, 2024

(54) ROBUST SCHEDULING WITH GENERATIVE FLOW NETWORKS

(71) Applicant: QUALCOMM Incorporated, San Diego, CA (US)

(72) Inventors: Corrado RAINONE, Haarlem (NL); Wei David ZHANG, Amsterdam (NL); Roberto BONDESAN, London (GB); Markus PESCHL, Amsterdam (NL); Mukul GAGRANI, Milpitas, CA (US); Wonseok JEON, San Diego, CA (US); Edward TEAGUE, San Diego, CA (US); Piero ZAPPI, La Jolla, CA (US); Weiliang ZENG, San Diego, CA (US); Christopher LOTT, San Diego, CA (US)

(21) Appl. No.: 18/459,277

(22) Filed: Aug. 31, 2023

Related U.S. Application Data
(60) Provisional application No. 63/411,022, filed on Sep. 28, 2022.

(51) Int. Cl. G06F 9/48

(52) U.S. Cl. CPC G06F 9/4881; G06N 5/04

(57) ABSTRACT

A processor-implemented method includes generating, by a scheduling model, a group of schedules from a computation graph associated with a task, each node on the computation graph being associated with an operation of an artificial neural network, each schedule of the group of schedules associating each node of the computation graph with a processor of a group of processors of a hardware device. The processor-implemented method also includes testing one or more schedules of the group of schedules on the hardware device or a model of the hardware device. The processor-implemented method further includes selecting a schedule of the one or more schedules based on testing the one or more schedules, the selected schedule satisfying a selection condition.

### CROSS-REFERENCE TO RELATED APPLICATION

The present application claims the benefit of U.S. Provisional Patent Application No. 63/411,022, filed on Sep. 28, 2022, and titled “ROBUST SCHEDULING WITH GENERATIVE FLOW NETWORKS,” the disclosure of which is expressly incorporated by reference in its entirety.

### FIELD OF THE DISCLOSURE

Aspects of the present disclosure generally relate to scheduling tasks to resources.

### BACKGROUND

Artificial neural networks may comprise interconnected groups of artificial neurons (e.g., neuron models). The artificial neural network may be a computational device or be represented as a method to be performed by a computational device.

In some cases, tasks may be divided into multiple operations, and these operations may be assigned to one or more device resources, such as processors, based on a schedule. A scheduler may outline an order and timing for executing each operation on a particular resource based on a respective priority of each operation. Different schedules can lead to variations in the time it takes to perform computations associated with these operations. This scheduling process may be used for operations associated with a task that may be performed by the artificial neural network. An object recognition task is an example of a task that may be performed by the artificial neural network.

### SUMMARY

In some aspects of the present disclosure, a processor-implemented method includes generating, by a scheduling model, a group of schedules from a computation graph associated with a task, each node on the computation graph being associated with an operation of an artificial neural network, each schedule of the group of schedules associating each node of the computation graph with a processor of a group of processors of a hardware device. The processor-implemented method further includes testing one or more schedules of the group of schedules on the hardware device or a model of the hardware device. The processor-implemented method also includes selecting a schedule of the one or more schedules based on testing the one or more schedules, the selected schedule satisfying a selection condition.

Some aspects of the present disclosure are directed to an apparatus including means for generating, by a scheduling model, a group of schedules from a computation graph associated with a task, each node on the computation graph being associated with an operation of an artificial neural network, each schedule of the group of schedules associating each node of the computation graph with a processor of a group of processors of a hardware device. The apparatus also includes means for testing one or more schedules of the group of schedules on the hardware device or a model of the hardware device. The apparatus further includes means for selecting a schedule of the one or more schedules based on testing the one or more schedules, the selected schedule satisfying a selection condition.

In some aspects of the present disclosure, a non-transitory computer-readable medium with non-transitory program code recorded thereon is disclosed. The program code is executed by one or more processors and includes program code to generate, by a scheduling model, a group of schedules from a computation graph associated with a task, each node on the computation graph being associated with an operation of an artificial neural network, each schedule of the group of schedules associating each node of the computation graph with a processor of a group of processors of a hardware device. The program code further includes program code to test one or more schedules of the group of schedules on the hardware device or a model of the hardware device. The program code also includes program code to select a schedule of the one or more schedules based on testing the one or more schedules, the selected schedule satisfying a selection condition.

Some aspects of the present disclosure are directed to an apparatus including one or more processors, and one or more memories coupled with the one or more processors and storing processor-executable code that, when executed by the one or more processors, is configured to cause the apparatus to generate, by a scheduling model, a group of schedules from a computation graph associated with a task, each node on the computation graph being associated with an operation of an artificial neural network, each schedule of the group of schedules associating each node of the computation graph with a processor of a group of processors of a hardware device. Execution of the instructions also cause the apparatus to test one or more schedules of the group of schedules on the hardware device or a model of the hardware device. Execution of the instructions further cause the apparatus to select a schedule of the one or more schedules based on testing the one or more schedules, the selected schedule satisfying a selection condition.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 3 is a block diagram illustrating an example of scheduling a set of operations with precedence constraints on a fixed number of devices, in accordance with various aspects of the present disclosure.

FIGS. 4A and 4B are block diagrams illustrating an example of scheduling operations by a generative model, in accordance with various aspects of the present disclosure.

FIG. 5 is a flow diagram illustrating an example of a process for selecting a schedule, in accordance with various aspects of the present disclosure.

### DETAILED DESCRIPTION

The detailed description set forth below in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures, and in the following description of the preferred aspects. The detailed description and drawings are merely illustrative of the disclosure rather than limiting, the scope of the disclosure being defined by the appended claims and equivalents thereof.

In some cases, tasks may be divided into multiple operations, and these operations may be assigned to one or more device resources, such as (but not limited to) processors, based on a schedule. An object recognition task is an example of a task that may be performed by an artificial neural network. Aspects of the present disclosure are not limited to object recognition tasks, as other types of tasks are contemplated. A computational step, such as (but not limited to) matrix multiplication, involved in training or utilizing a neural network may be an example of an operation. Such operations may be parallelized over multiple processors (e.g., processing devices) of a device (e.g., hardware device). A scheduler may schedule the execution of these operations based on a respective priority of each operation in accordance with an availability of processing devices to reduce a total runtime (e.g., makespan) associated with the task. Different schedules can lead to variations in the time it takes to perform computations associated with these operations.

Scheduling operations, such as operations in a computational graph (also referred to as computation graph), to reduce a total runtime (e.g., makespan) associated with a task is an example of a non-deterministic polynomial (NP)-hard problem. Evaluating an effectiveness of a schedule on hardware may be computationally expensive. Some conventional systems use machine learning techniques to evaluate the schedule. In some such systems, to decrease an evaluation time, the schedule may be evaluated on a proxy associated with the hardware. The proxy captures characteristics of the target hardware that influence the schedule's performance. For example, the proxy may account for factors, such as (but not limited to) processing speed, memory bandwidth, communication latency, other hardware-specific parameters, etc. The proxy may be a machine learning model or another type of system that is not trained on data. Conventional systems assume that a schedule that minimizes the makespan on the proxy will equate to a minimized makespan on the hardware. However, the proxy may not accurately estimate one or both of a latency or a bandwidth associated with the hardware. Therefore, the proxy may not be an accurate representation of the hardware.

Various aspects of the present disclosure are directed to improving operation scheduling. In some examples, a group of schedules may be generated by a scheduling model. The group of schedules may then be evaluated on a proxy, and then one or more schedules of the group of schedules may be evaluated on the hardware or a model of the hardware. In some examples, the group of schedules may be fine-tuned based on hardware specifications and/or desired performance goals, presenting a more versatile and adaptable approach to the scheduling problem. In some implementations, after testing the one or more schedules on the hardware, a schedule associated with a lower or lowest makespan may be selected as a final schedule.

Particular aspects of the subject matter described in this disclosure can be implemented to realize one or more of the following potential advantages. In some examples, the combination of generating a group of schedules by the scheduling model, filtering the group of schedules via a proxy, and then evaluating one or more schedules of the group of schedules on test hardware or a model of the test hardware may reduce computational costs while reducing a total makespan of a schedule. As a result, aspects of the present disclosure improve the scheduling of operations to improve a speed of tasks and reduce resource use (e.g., memory and/or processor use).

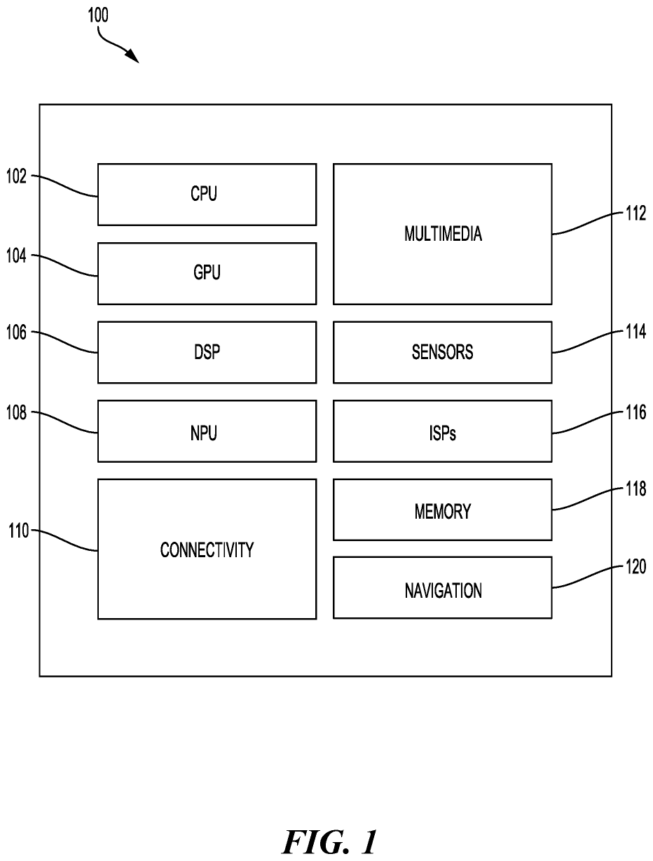

FIG. 1 illustrates an example implementation of a system-on-a-chip (SOC) 100, which may include a central processing unit (CPU) 102 or a multi-core CPU configured for robust scheduling with generative flow networks. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to generate, by a scheduling model, a group of schedules from a computation graph associated with a task, each node on the computation graph being associated with an operation of an artificial neural network, each schedule of the group of schedules associating each node of the computation graph with a processor of a group of processors of a hardware device. The code may also include code to test one or more schedules of the group of schedules on the hardware device or a model of the hardware device; and code to select a schedule of the one or more schedules based on testing the one or more schedules, the selected schedule satisfying a selection condition.

Object recognition is an example of a task performed by an artificial neural network. In some examples, an object recognition task learns to represent inputs at successively higher levels of abstraction in each layer, thereby building up a useful feature representation of the input data.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

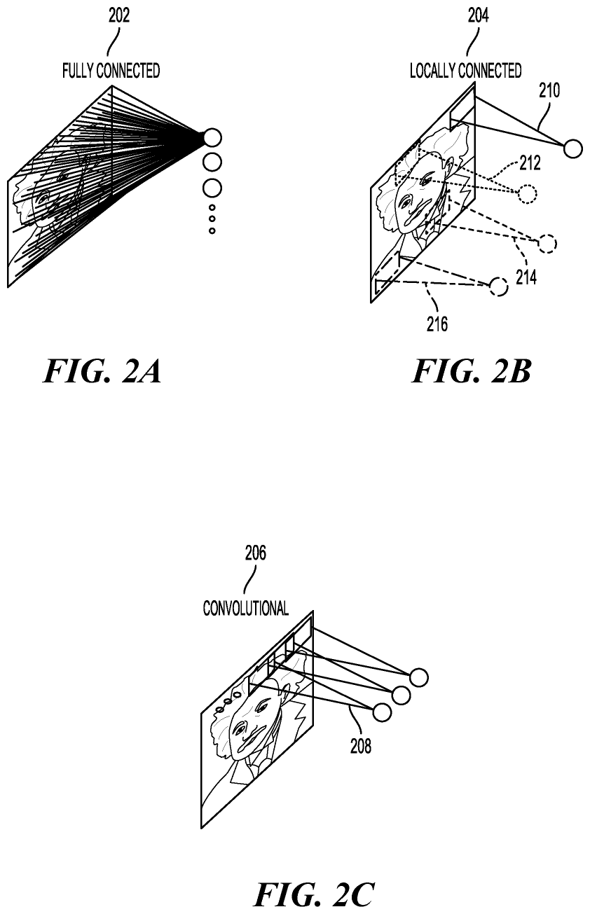

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

In some examples, a task performed by an artificial neural network, such as an inference task, may involve a set of operations, such as matrix multiplications. Such operations may be parallelized over multiple device resources (e.g., processors). A scheduler may schedule these operations on available device resources to reduce a total runtime (e.g., makespan) associated with the task. The makespan may be dependent on the hardware and may not be easily measurable due to a resource cost and/or time associated with executing a task on the hardware. Therefore, it may not be practical to use hardware runtime as a factor for optimizing a schedule. Thus, instead of using the hardware runtime, some systems evaluate a schedule using a proxy of the hardware.

It may be desirable to efficiently execute tasks associated with an operation (e.g., computation graph) in various scientific and industrial applications. Scheduling may assign operations to available computational resources, such as (but not limited to) threads, cores, nodes in a cluster, etc. Finding the optimal schedule with the shortest possible makespan (start-to-end runtime) is generally an NP-hard problem, making exact resolution functions impractical. As a result, some conventional systems use a heuristic approach tailored to specific instances by human operators. Other conventional systems may use a machine learning (ML) approach.

In some examples, a set of operations with precedence constraints may be scheduled on a fixed number of homogeneous devices. In some conventional systems, in order to evaluate a makespan of the schedule, all tasks associated with the schedule may be executed on the target hardware. Evaluating the makespan on the target hardware may be highly resource-intensive. Heuristic optimizers and machine learning methods exacerbate this issue, as they often necessitate numerous evaluations to achieve satisfactory performance. Furthermore, the effectiveness of any solution may be dependent on the specific hardware used.

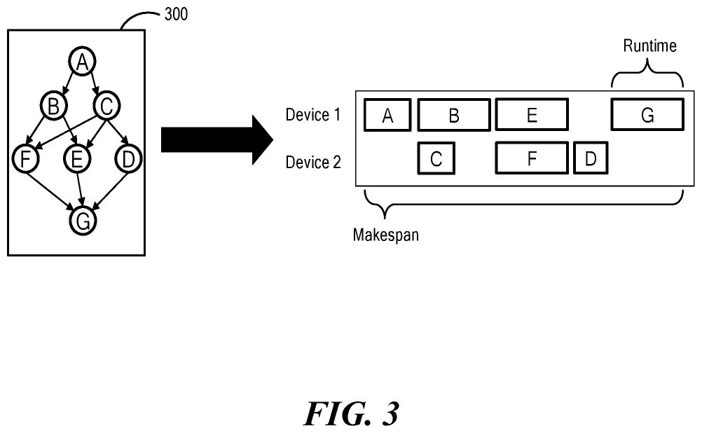

FIG. 3 is a block diagram illustrating an example of scheduling a set of operations 300 with precedence constraints on a fixed number of devices, in accordance with various aspects of the present disclosure. In the example of FIG. 3, the set of operations 300 is represented by a computation graph that includes operations labeled A-G. In the example of FIG. 3, the computation graph encodes the precedence constraint of each operation after an initial operation A. The precedence constraint encodes the dependency of each operation. For example, in FIG. 3, the fifth operation E is dependent on the output of the second operation B and the third operation C. In some examples, an operation may be dependent on the output of one or more operations when the task is a computation of a forward pass of a neural network, where the outputs of one or more layers are fed as inputs to a subsequent layer.

As shown in the example of FIG. 3, the set of operations 300 may be scheduled to execute on a set of devices (shown as Device 1 or Device 2), in accordance with the precedence constraints. For example, the first operation A may be scheduled on the first device (Device 1), then the second operation B may be scheduled to execute after the first operation A on the first device (Device 1) and the third operation C may be scheduled to execute after the first operation A on the second device (Device 2). The second operation B and the third operation C are scheduled after completion of the first operation A because both operations B and C are dependent on the output of the first operation A. Each operation may be associated with a runtime that needs to elapse between the start and the end of the operation's execution on a device. During this time, the device may be considered occupied and cannot be used to execute other operations. Furthermore, a total runtime for the operations may be referred to as a makespan.

To mitigate the computational burden, some conventional systems use a proxy, which may provide a faster alternative by estimating the makespan using a simplified model of the hardware. However, this comes at the cost of discrepancies between the proxy makespan and the actual makespan observed on the hardware, potentially leading to unsatisfactory performance when tested on the target. Despite these limitations, proxies generally serve as a good indicator for most schedules.

A conventional solution to scheduling problems and combinatorial optimization is to seek the best schedule based on a makespan measure, which can be represented by a mathematical proxy, an output of a simulator, or a makespan observed on hardware. Some conventional systems use reinforcement learning to optimize the makespan in computation graph schedules. These conventional systems may use various reward objectives, ranging from simple mathematical proxies of the makespan to sophisticated proxies that incorporate memory movement modeling.

In contrast to conventional systems, aspects of the present disclosure are directed to generating a diverse set of schedules using a generative model. Specifically, instead of focusing solely on finding a single optimal schedule, aspects of the present disclosure are directed to training a generative model that assigns higher probabilities to low-makespan schedules while discovering various modes associated with local optima of the makespan cost. The generative model may be an example of a generative flow network (GFlowNet) (hereinafter used interchangeably) that learns stochastic policies capable of constructing discrete and composite objects step-by-step, based on a given unnormalized density. By controlling the set of valid actions during construction, only feasible schedules are sampled. This approach allows a scheduling system to evaluate multiple good schedules that differ significantly from each other, thus reducing the impact of systematic errors in the proxy and increasing the potential for robust performance on the target hardware.

In some examples, a reliance on a proxy metric is reduced by generating multiple candidate schedules, which are directly evaluated on the target hardware. The scheduling model (e.g., GFlowNet) may generate schedules that are conditioned on a computation graph. Aspects of the present disclosure may be applicable to synthetic and real-world computation graphs.

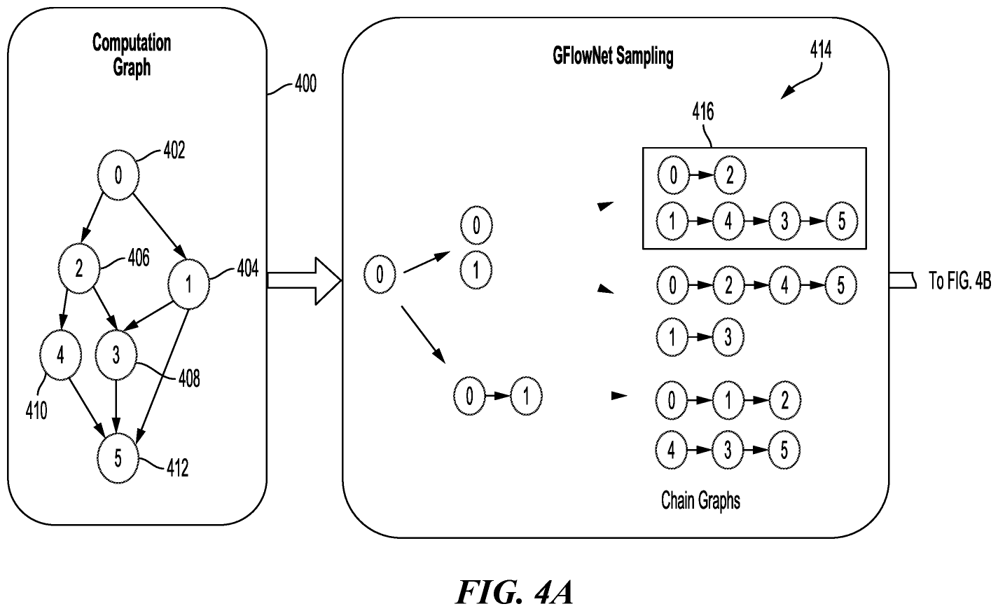

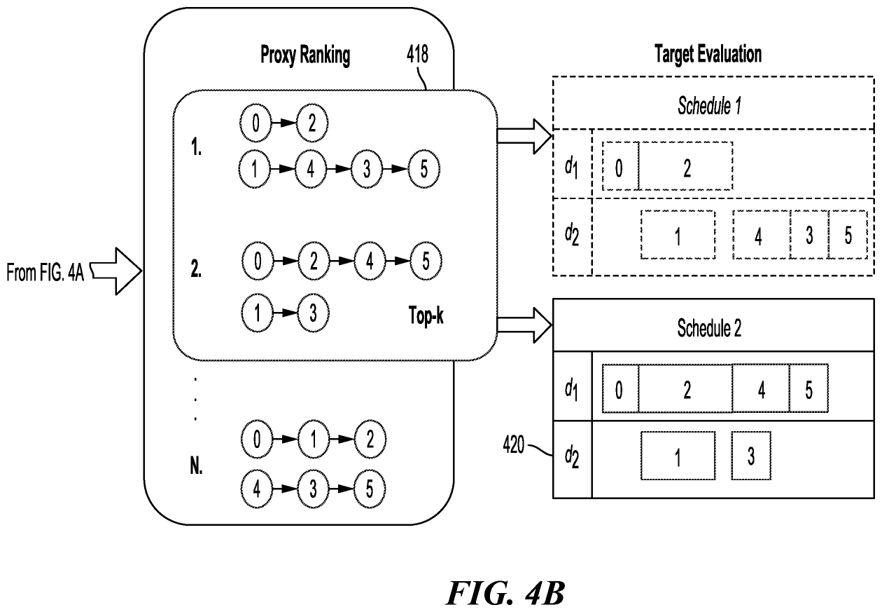

FIGS. 4A and 4B are block diagrams illustrating an example of scheduling operations, in accordance with various aspects of the present disclosure. In the example of FIGS. 4A and 4B, a task may be associated with a set of operations 402, 404, 406, 408, 410, and 412 that may be executed on a set [symbol] ={d₁, . . . , dₘ} of devices. In some examples, the set of operations 402, 404, 406, 408, 410, and 412 may be represented by a computation graph 400 G_{C}=(O,P) that is a direct acyclic graph (DAG) consisting of operations (nodes) o∈O and precedence constraints (edges) p∈P. For example, in the examples of FIGS. 4A and 4B, the set of operations includes six operations (0-5). Each operation oᵢ is associated with a runtime that needs to elapse between the start and the end of its execution on a device. During this time, the device may be considered occupied and cannot execute other operations. In the examples of FIGS. 4A and 4B, an edge pᵢⱼ encodes a first operation oᵢ, which needs to finish before a second operation oⱼ can start, for example, because the second operation oⱼ requires the output of the first operation oᵢ as input. For example, in the example of FIG. 4A, the fourth operation 408 is dependent on the output of the second and third operations 404 and 406. In some examples, an operation may be dependent on the output of one or more operations when the task is a computation of a forward pass of a neural network, where the outputs of one or more layers are fed as inputs to a subsequent layer.

In some implementations, the set of operations 402, 404, 406, 408, 410, and 412 may be executed on a given set of devices [symbol] ={d₁, . . . , dₘ}, while adhering to the precedence constraints defined by the computation graph 400 G_{C}. In addition to the precedence constraints, each device may only handle one operation at a time. Consequently, the scheduling problem involves two main tasks: first, assigning a device to each operation, and second, determining a compatible (complete) order of operations on each device, considering the precedence constraints encoded in the computation graph 400 G_{C}. The schedule may be represented as a sequence of operations for each device, where the sequence indicates the order in which the operations are executed on that specific device. Aspects of the present disclosure are directed to finding the optimal schedule that results in the lowest makespan for the target hardware.

In the example of FIG. 4A, a generative model (e.g., GFlowNet) may generate a group of candidate schedules 414 based on the set of operations 402, 404, 406, 408, 410, and 412 and a number of devices in the set of devices [symbol] . For ease of explanation, the examples of FIGS. 4A and 4B are limited to two devices. Aspects of the present disclosure are not limited to two devices, as additional devices may execute the operations. Each candidate schedule may be represented by one chain graph per device. For example, a first candidate schedule 416 is represented by a first chain graph having a first operation 402 and a third operation 406 (shown as 0→2) scheduled on a first device, and a second chain graph having a second operation 404, a fourth operation 408, a fifth operation 410, and a sixth operation 412 scheduled on a second device (shown as 1→4→3→5). Thus, the group of candidate schedules 414 may be represented by a group of chain graphs.

A schedule is an order of operations for each device, which can be represented by one chain graph per device. For each chain graph, C_{d}, d∈ [symbol] may represent the set of edges of the chain graph for device d and D:=∪ₖ₌₁^{m}C_{d}_{ₖ} may represent the set of all device constraints. The operations in each chain graph correspond to operations 402, 404, 406, 408, 410, and 412 in the computation graph 400 G_{C} and are labeled in the same way as the computation graph 400 G_{C}. No other operation can run on the same device during the runtime (e.g., duration) ρᵢ of an operation oᵢ. In some examples, the runtime ρᵢ is estimated directly on the hardware in a profiling stage that precedes scheduling. A parameter τᵢ represents a start time of the operation oᵢ. The precedence constraints may be expressed as:

τⱼ^{s}>τᵢ^{s}+ρᵢ, ∀(i,j)∈P∪D (1)

In Equation 1, (i,j)∈P∪D represents an edge in the computation graph 400 G_{C}. An edge (i,j) indicates a dependency relationship between two operations oᵢ and oⱼ. That is, the output of a first operation oᵢ is required as an input for a second operation oⱼ. Therefore, based on Equation 1, a start time of the second operation oⱼ is greater than a start time of the first operation oᵢ and a runtime ρᵢ of the second operation oᵢ for all pairs of operations (oᵢ, oⱼ) connected by an edge in the computation graph 400 G_{C}. As discussed, in some cases, an operation oᵢ cannot start unless all of those operations that produce its inputs and all of those operations that precede it on its assigned device have finished first. To ensure that these constraints are satisfied, the proxy assigns each operation oᵢ a start time based on Equation 2:

$${τ}_{i} = {max}_{k} \{ {τ}_{k} + {ρ}_{k} \vert ( k , i ) ∈ P ⋃ D \} . \qquad ( 2 )$$

If a node has no parents in P∪D, the proxy assigns the start time τᵢ=0. The start times of all operations oᵢ∈O can be computed by assigning a start time to a node whenever it has no parents or all its parents have an assigned start time. If the graph (O, P∪D) is a DAG, then this function assigns start times that satisfy Equation 2. The proxy then estimates the makespan T of the schedule x as:

$$T ( x ) := {max}_{i} ( {τ}_{i} + {ρ}_{i} ) - {min}_{i} ( {τ}_{i} ) \qquad ( 3 )$$

In Equation 3, the makespan T(x) represents a time elapsed between a start of an initial operation (minᵢ(τᵢ)) and an end of a final operation (maxᵢ(τᵢ+ρᵢ)).

For ease of explanation, it is assumed that the runtimes ρᵢ of operations oᵢ are constants and independent of the devices [symbol] they are executed on. Additionally, in Equation 1, it is assumed that an operation can start immediately after all operations producing its inputs finish, without any delay. In some examples, actual runtimes ρᵢ of operations oᵢ may vary depending on the devices [symbol] used, and there could be delays in starting an operation oᵢ due to various factors, such as resource contention, communication overhead, or synchronization requirements. As a result, the predicted makespan T of a schedule x, based on these assumptions, may differ from the actual makespan T observed when the schedule x is executed in real-world environments. Nonetheless, aspects of the present disclosure still provide a solution for reducing the makespan T when the schedule x is executed in real-world environments.

As discussed, evaluating candidate schedules on target hardware involves executing all operations in the specified order and on the designated devices. However, this process can be time-consuming and computationally demanding, especially for large computation graphs with resource-intensive operations or when operating with multi-node target hardware configurations. To reduce the computational burden, a proxy may be used to estimate the makespan of each candidate schedule of the group of candidate schedules generated by the GFlowNet without physically running the operations on the target hardware. The proxy provides a quicker approximation of the makespan based on a simplified model of the computation graph or hardware setup, thereby avoiding time-consuming executions on the actual hardware. Still, proxies may be prone to mistakes in the relative comparison of candidate schedules. These mistakes may occur when task durations are not accurately profiled, memory movements are too complex to fully model, or additional hardware-specific features are changed. As discussed, systematic errors in the proxy may cause the proxy to incorrectly predict a low makespan for some candidate schedules. Therefore, the set of candidate schedules 414 should be diverse, while still satisfying a baseline makespan condition from the point of view of the proxy. A candidate schedule may satisfy the baseline makespan condition by having at least a baseline makespan that is determined by a manufacturer or other entity.

In the examples of FIGS. 4A and 4B, each one of the group of candidate schedules 414 generated by the GFlowNet may be tested (e.g., executed) on a proxy. The proxy may then generate a ranking of the candidate schedules (1 to N) based on a respective makespan associated with each candidate schedule. The ranking may rank the schedules in order of lowest makespan to highest makespan. For example, a candidate schedule with a lowest makespan, from the group of candidate schedules 414, may be ranked first. While the proxy is imperfect, it offers good guidance for most schedules. After ranking the group of candidate schedules 414, as shown in the example of FIG. 4A, a subset of candidate schedules 418 (e.g., the top-k schedules) may be tested on actual hardware or a model of the actual hardware, as shown in the example of FIG. 4B. A candidate schedule from the subset of candidate schedules 418 associated with a lowest makespan based on the evaluation of the candidate schedules 418 on the actual hardware or a model of the actual hardware may be selected as a final schedule. In the example of FIG. 4B, a second schedule 420 is selected as the final schedule.

As discussed, the GFlowNet (e.g., generative model) generates a group of candidate schedules for reducing a makespan T(x) of a final schedule. The scheduling process is executed in a step-by-step manner, where an empty schedule corresponds to an initial state s₀, a full schedule represents the final state s_{N}, and each state s t denotes a partial schedule. At each intermediate state sₜ, the neural agent makes decisions (e.g., actions aₜ) by selecting an operation oᵢ and assigning it to one of the devices, effectively adding the operation oᵢ to the schedule x. The set of valid actions aₜ at each step t may be defined in a way that ensures the precedence constraints are satisfied. For instance, adding an operation oₜ may be valid if its parent operation oₖ has already been added to the schedule in a previous state sₜ (e.g., ∀k: (k,t)∈P)). This condition may be used to form a directed acyclic graph (DAG) based on a final schedule graph (O, P∪D), implying that the constructed schedule is feasible. The final state s_{N} represents full schedules x. A makespan T(x) may be computed for each schedule x using the proxy, given the runtimes {ρᵢ}ᵢ₌₁ⁿ. To evaluate the performance of a schedule x, the relative speedup may be compared to the makespan T(x) on a single device. The relative speedup may be computed as U(x)=Σᵢρᵢ/T(x). The speedup U(x) may be the sum of the runtimes of all operations Σᵢρᵢ divided by the makespan T(x) of the schedule x. A higher value of the speedup U(x) means that the schedule x is more efficient and completes the operations in less time compared to the sequential execution. A reward may be determined from the speedup U(x), which may be used in the learning process of the neural agent.

A GFlowNet is an example of a type of an artificial neural network for training a policy to sample discrete and composite objects proportionally to a given unnormalized density. Each state x (which differs from a schedule x) may be incrementally generated by a sequence of actions. In some examples, a trajectory s includes a sequence of states sₜ, such that s=(s₀, s₁, . . . , sₙ). For scheduling, trajectories s begin with an empty schedule s₀, followed by partial schedules, and finally, a complete schedule sₜ. A parameter [symbol] represents a set of all such trajectories and a parameter [symbol] ₓ represents a set of trajectories that end at the state x. A flow function may be represented as F: [symbol] → [symbol] ⁺ associated with a normalized probability distribution P(s)=F(s)/Z, Z= [symbol] F(s). A flow function F that fulfills the condition: R(x)= [symbol] F(s) (every terminal state x has a total flow matching its reward), results in a probability over schedules P(x)= [symbol] F(s)/Z that is proportional to the reward P(x)∝R(x), and further entails that Z=ΣₓR(x). For a Markovian flow, the probability of a trajectory may be decomposed in terms of the forward probability, as:

P(s)=Πₜ₌₁ⁿP_{F}(sₜ|sₜ₋₁) (4)

Equation 4 expresses the probability of a trajectory s as the product of individual conditional probabilities P_{F}(sₜ|sₜ₋₁), which describe the likelihood of transitioning from one state sₜ₋₁ to another state sₜ at each time step t. This decomposition simplifies the modeling and computation of probabilities in a Markovian flow setting, making it more tractable for various scheduling tasks. Thus, trajectories T may be generated by sampling a sequence of actions starting from s₀. In some examples, a backward probability P_{B} factorizes the probability of a trajectory conditioned on a terminal state:

P(s|sₙ=x)=Πₜ₌₁ⁿP_{B}(sₜ₋₁|sₜ) (5)

Equation 5 expresses the likelihood of transitioning from state sₜ to state sₜ₋₁ at each time step t, given that the terminal state x of the trajectory. The backward probability P_{B} models the reverse transitions of the trajectory to determine how states progress backward from the final state sₙ to the initial state s₀. By considering both forward and backward probabilities, aspects of the present disclosure may comprehensively capture the dynamics of the trajectory s.

In conventional generative models (e.g., GFlowNets), the training objectives have focused on achieving a consistent flow, where consistency implies that the estimated flow for the forward direction should be equal to the flow for the backward direction. For trajectories s∈ [symbol] ₓ, a consistent flow F(s) can be expressed in terms of the forward probability P_{F} and the backward probability P_{B} and should fulfill the following equality:

ZΠₜ₌₁ⁿP_{F}(sₜ|sₜ₋₁)=R(x)Πₜ₌₁ⁿP_{B}(sₜ₋₁|sₜ) (6)

Based on Equation 6, the normalization constant Z, the forward probability P_{F}, and the backward probability P_{B} are estimated by optimizing the trajectory balance loss, which is defined as the squared difference between the logarithms of the left-hand side and the right-hand side of Equation 6. The trajectory balance loss allows the neural network to learn the flow functions P_{F} and P_{F} that accurately represent the dynamics of the trajectories in both the forward and backward directions. By minimizing this loss, the network can balance the probabilities, such that the estimated flow is consistent, thereby improving the quality of the generated schedules. This approach improves the reliability and accuracy of scheduling results.

To apply the trajectory balance loss in the conditional case, an additional regression model may estimate the logarithm of the partition function log Z conditioned on the computation graph G_{C}. Accurately training such a regression model can be challenging but necessary for learning the forward probability P_{F}. Incorrectly estimating the partition function log Z can lead to the wrong direction of gradients in the loss function, which hinders the learning process. In some examples, Equation 6 may be reformulated to implicitly estimate the partition function log Z based on the forward and backward flows of a single trajectory s. Here, the forward probability P_{F} and the backward probability P_{B} are neural networks with learnable parameters θ:

ζ(s;θ)=log R(x)+Σₜ₌₁ⁿ log P_{B}(sₜ₋₁|sₜ;θ)−Σₜ₌₁ⁿ log P_{F}(sₜ|sₜ₋₁;θ) (7)

In Equation 7, ζ(s; θ) represents the estimated logarithm of the partition function for the trajectory s using the forward probability P_{F} and the backward probability P_{B} neural networks with the learnable parameters θ. In some examples, ζ(s;θ) is equal to the true log Z, which is the same for all trajectories corresponding to the same computation graph G_{C}. That is, log Z may be implicitly estimated without explicitly computing it, making the optimization more stable and effective. Thus, the optimization goal turns into minimizing the variance of ζ(s;θ) over different trajectories s with a log partition variance loss [symbol] (s;θ), thereby improving the consistency and reliability of the flow-based policy network. The log partition variance loss [symbol] _{V}(s;θ) may be determined as follows:

[symbol]

_{V}(s;θ)=(ζ(s;θ)− [symbol] ₛ[ζ(s;θ)])² (8)

By optimizing the log-partition variance loss [symbol] _{V}(s;θ) in Equation 8, only the forward and backward probabilities P_{F} and P_{B} may be parametrized. The log-partition variance loss [symbol] _{V}(s;θ) does not mix forward and backward steps from different trajectories. Rather, the log-partition variance loss [symbol] _{V}(s;θ) directly optimizes the consistency of the total flow Z for each trajectory associated with a given computation graph G_{C}.

In some examples, a reward for the GFlowNet may be a function of a speedup of a schedule. In some such examples, the reward R may be defined as log R(x;m,σ)=(U(x)−m)/σ, where the function U(x) represents the speedup of the schedule x, the parameter m represents the number of devices, and the parameter σ∈ [symbol] ⁺ represents a temperature parameter. The temperature parameter σ concentrates the distribution of generated schedules on a mode corresponding to schedules with higher speedup values. By adjusting the temperature parameter σ, a spread of the distribution may be controlled to focus more on schedules that have better performance in terms of speedup.

Additionally, the temperature parameter a may control, in part, the selectivity of the generator. In practice, there are often many more schedules with low speedup compared to schedules with high speedup. If the raw speedup is used as the reward, finding schedules with high speedup would require an impractical number of samples. By introducing the temperature parameter σ, the sampling distribution may be adjusted toward schedules with a greater speedup, such that high-performance schedules may be identified via the sampling process. Accordingly, the reward temperature provides a balance between diversity in the generated schedules and shifting a mean of the sampling distribution toward schedules with a greater speedup.

Conventional GFlowNets use a constant temperature value throughout training and inference. This constant temperature can result in suboptimal performance when set too high, leading to a lack of diversity or unstable training when set too low. Additionally, different computation graphs may require different temperature values to achieve optimal results, making the constant temperature approach less suitable for learning conditional GFlowNets.

In some aspects of the present disclosure, a single model may handle multiple reward functions R(x;m,σ) by conditioning the policy networks (P_{F} and P_{B}) on the temperature parameter σ, such that the temperature parameter σ may be adaptively adjusted during training and inference. Adaptively adjusting the temperature parameter a may improve the model's performance and stability. By approximating a temperature-conditioned policy with a neural network, the model may learn how flows for a given temperature can be transformed into flows for other temperatures. In such examples, the reward function R(x;m,σ) remains continuous with respect to the temperature σ. As a result, the change in flow for different temperature parameter σ values may be learned by the neural network. By learning the change in flow, the model may test a range of temperature parameter σ values and adapt to the one or more characteristics of different computation graphs.

The following theorem establishes the continuity of the reward function. The parameter {Rᵢ}ᵢ₌₁^{∞} represents a sequence of positive reward functions, such that for all terminal states x, Rᵢ(x)→R(x) as i→∞. Then, for any flow F^{R} with reward R, there exists a sequence of flow functions {F^{R}^{ᵢ}}ᵢ₌₁^{∞} with F^{R}^{ᵢ}(s)→F^{R}(s) for all s∈ [symbol] . The theorem states that for a sequence of reward functions {Rᵢ}ᵢ₌₁^{∞} that gradually converges to a common reward function R as i approaches infinity, then the corresponding sequence of flow functions {F^{R}^{ᵢ}}ᵢ₌₁^{∞} will also converge to the flow function F^{R} associated with the common reward R.

During training, the temperature parameter σ may be sampled from the log-uniform distribution, which has support between [log σₘᵢₙ, log σₘₐₓ], where σₘᵢₙ is the minimum temperature chosen for numerical stability purposes. Using the log-uniform distribution for sampling the temperature σ has the advantage of avoiding oversampling from high temperature regions that may lead to little difference in the resulting network flow. By taking the logarithm of the temperature values, the sampling becomes more balanced across the entire range of possible temperature values. At inference time, the value of the temperature parameter σ may be adjusted to control how close the samples generated by the GFlowNet are to the mode. The mode refers to the region with the highest probability density in the probability distribution.

In some examples, a topoformer model may be used for the neural network architecture. The topoformer model may be specifically designed for learning topological orderings of computation graphs. This architecture may be adapted to handle the unique topology of the computation graph. In some instances, a multi-head attention mechanism of the architecture may perform a masking operation based on the graph's structure. Both the forward and backward policies use separate multi-layer perceptron (MLP) heads on top of a shared topoformer encoder. The temperature parameter σ may be first embedded using an MLP to produce a temperature embedding e_{σ}. This temperature embedding e_{σ} may be reused in every first linear layer block of the topoformer, as follows:

lin(h,e_{σ})=lin_{scale}(e_{σ})⊙lin(h)+lin_{shift}(e_{σ}) (9)

In Equation 9, lin_{scale}(e_{σ}) and lin_{shift}(e_{σ}) are linear transformations applied to the temperature embedding e_{σ}, and ⊙ denotes element-wise multiplication. This temperature conditioning allows the neural network to adapt its behavior based on the temperature parameter σ during training and inference, such that the neural network may learn diverse reward functions.

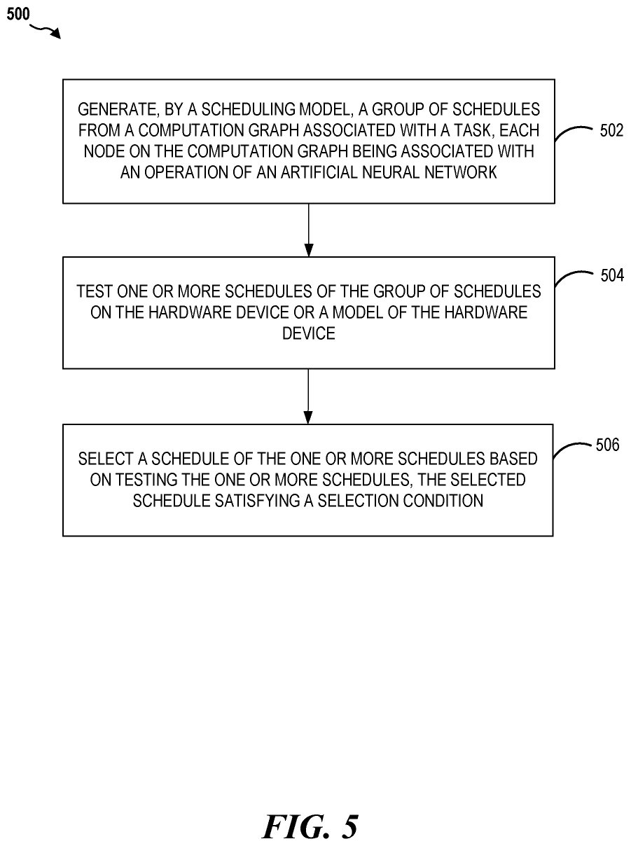

FIG. 5 is a flow diagram illustrating an example of a process 500 for selecting a schedule, in accordance with various aspects of the present disclosure. As shown in FIG. 5, the process 500 begins at block 502 by generating, by a scheduling model, a group of schedules from a computation graph associated with a task. Each node on the computation graph may be associated with an operation of an artificial neural network. Aspects of the present disclosure are not limited to scheduling operations of an artificial neural network, as other types of operations may also be scheduled. Additionally, each schedule of the group of schedules may associate each node of the computation graph with a processor of a group of processors of a hardware device. At block 504, the process 500 tests one or more schedules of the group of schedules on the hardware device or a model of the hardware device. At block 506, the process 500 selects a schedule of the one or more schedules based on testing the one or more schedules, the selected schedule satisfying a selection condition.

Implementation examples are described in the following numbered clauses:
Clause 1. A processor-implemented method comprising: generating, by a scheduling model, a group of schedules from a computation graph associated with a task, each node on the computation graph being associated with an operation of an artificial neural network, each schedule of the group of schedules associating each node of the computation graph with a processor of a group of processors of a hardware device; testing one or more schedules of the group of schedules on the hardware device or a model of the hardware device; and selecting a schedule of the one or more schedules based on testing the one or more schedules, the selected schedule satisfying a selection condition.
Clause 2. The processor-implemented method of Clause 1, wherein the scheduling model is a generative flow network.
Clause 3. The processor-implemented method of any one of Clauses 1-2, wherein each schedule of the group of schedules is associated with a makespan.
Clause 4. The processor-implemented method of Clause 3, wherein the makespan is a total time between a start of an initial operation and an end of a final operation associated with the schedule.
Clause 5. The processor-implemented method of any one of Clauses 1-4, wherein the selected schedule satisfies the selection condition based on the makespan of the selected schedule having a lowest value among each respective makespan associated with the one or more schedules.
Clause 6. The processor-implemented method of any one of Clauses 1-5, wherein the task is an inference task performed by the artificial neural network.
Clause 7. The processor-implemented method of any one of Clauses 1-6, wherein the task is a hierarchical task.
Clause 8. The processor-implemented method of any one of Clauses 1-7, wherein the scheduling model is trained, on a proxy of the hardware device, to minimize a makespan associated with a training schedule.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method, comprising:
generating, by a scheduling model, a group of schedules from a computation graph associated with a task, each node on the computation graph being associated with an operation of an artificial neural network, each schedule of the group of schedules associating each node of the computation graph with a processor of a group of processors of a hardware device;
testing one or more schedules of the group of schedules on the hardware device or a model of the hardware device; and
selecting a schedule of the one or more schedules based on testing the one or more schedules, the selected schedule satisfying a selection condition.

2. The processor-implemented method of claim 1, wherein the scheduling model is a generative flow network.

3. The processor-implemented method of claim 1, wherein each schedule of the group of schedules is associated with a makespan.

4. The processor-implemented method of claim 3, wherein the makespan is a total time between a start of an initial operation and an end of a final operation associated with the schedule.

5. The processor-implemented method of claim 3, wherein the selected schedule satisfies the selection condition based on the makespan of the selected schedule having a lowest value among each respective makespan associated with the one or more schedules.

6. The processor-implemented method of claim 1, wherein the task is an inference task performed by the artificial neural network.

7. The processor-implemented method of claim 1, wherein the task is a hierarchical task.

8. The processor-implemented method of claim 1, wherein the scheduling model is trained, on a proxy of the hardware device, to minimize a makespan associated with a training schedule.

9. An apparatus comprising:
means for generating, by a scheduling model, a group of schedules from a computation graph associated with a task, each node on the computation graph being associated with an operation of an artificial neural network, each schedule of the group of schedules associating each node of the computation graph with a processor of a group of processors of a hardware device;
means for testing one or more schedules of the group of schedules on the hardware device or a model of the hardware device; and
means for selecting a schedule of the one or more schedules based on testing the one or more schedules, the selected schedule satisfying a selection condition.

10. The apparatus of claim 9, wherein the scheduling model is a generative flow network.

11. The apparatus of claim 9, wherein each schedule of the group of schedules is associated with a makespan.

12. The apparatus of claim 11, wherein the makespan is a total time between a start of an initial operation and an end of a final operation associated with the schedule.

13. The apparatus of claim 11, wherein the selected schedule satisfies the selection condition based on the makespan of the selected schedule having a lowest value among each respective makespan associated with the one or more schedules.

14. The apparatus of claim 9, wherein the task is an inference task performed by the artificial neural network.

15. The apparatus of claim 9, wherein the task is a hierarchical task.

16. The apparatus of claim 9, wherein the scheduling model is trained, on a proxy of the hardware device, to minimize a makespan associated with a training schedule.

17. An apparatus comprising:
one or more processors; and
one or more memories coupled with the one or more processors and storing processor-executable code that, when executed by the one or more processors, is configured to cause the apparatus to:
generate, by a scheduling model, a group of schedules from a computation graph associated with a task, each node on the computation graph being associated with an operation of an artificial neural network, each schedule of the group of schedules associating each node of the computation graph with a processor of a group of processors of a hardware device;
test one or more schedules of the group of schedules on the hardware device or a model of the hardware device; and
select a schedule of the one or more schedules based on testing the one or more schedules, the selected schedule satisfying a selection condition.

18. The apparatus of claim 17, wherein the scheduling model is a generative flow network.

19. The apparatus of claim 17, wherein each schedule of the group of schedules is associated with a makespan.

20. The apparatus of claim 19, wherein the makespan is a total time between a start of an initial operation and an end of a final operation associated with the schedule.

21. The apparatus of claim 19, wherein the selected schedule satisfies the selection condition based on the makespan of the selected schedule having a lowest value among each respective makespan associated with the one or more schedules.

22. The apparatus of claim 17, wherein the task is an inference task performed by the artificial neural network.

23. The apparatus of claim 17, wherein the task is a hierarchical task.

24. The apparatus of claim 17, wherein the scheduling model is trained, on a proxy of the hardware device, to minimize a makespan associated with a training schedule.

25. A non-transitory computer-readable medium having program code recorded thereon, the program code executed by one or more processors and comprising:
program code to generate, by a scheduling model, a group of schedules from a computation graph associated with a task, each node on the computation graph being associated with an operation of an artificial neural network, each schedule of the group of schedules associating each node of the computation graph with a processor of a group of processors of a hardware device;
program code to test one or more schedules of the group of schedules on the hardware device or a model of the hardware device; and
program code to select a schedule of the one or more schedules based on testing the one or more schedules, the selected schedule satisfying a selection condition.

26. The non-transitory computer-readable medium of claim 25, wherein the scheduling model is a generative flow network.

27. The non-transitory computer-readable medium of claim 25, wherein each schedule of the group of schedules is associated with a makespan.

28. The non-transitory computer-readable medium of claim 27, wherein the makespan is a total time between a start of an initial operation and an end of a final operation associated with the schedule.

29. The non-transitory computer-readable medium of claim 27, wherein the selected schedule satisfies the selection condition based on the makespan of the selected schedule having a lowest value among each respective makespan associated with the one or more schedules.

30. The non-transitory computer-readable medium of claim 25, wherein the task is an inference task performed by the artificial neural network.
